(19) United States
(12) Patent Application Publication
(10) Pub. No.: US 2022/0366521 A1
(43) Pub. Date: Nov. 17, 2022

(54) CONTROL DEVICE, CONTROL METHOD, AND PROGRAM STORAGE MEDIUM

(71) Applicant: NEC Corporation, Minato-ku, Tokyo (JP)

(72) Inventor: Takeharu KITAGAWA, Tokyo (JP)

(73) Assignee: NEC Corporation, Minato-ku, Tokyo (JP)

(21) Appl. No.: 17/770,742

(22) PCT Filed: Oct. 12, 2020
(86) PCT No.: PCT/JP2020/038486

§ 371 Date: Apr. 21, 2022

(30) Foreign Application Priority Data
Nov. 6, 2019 (JP) 2019-201100

(51) Int. Cl. G06T 1/00; G06T 7/50; G05B 19/4155

(52) U.S. Cl. CPC G06T 1/0014; G06T 7/50; G05B 19/4155; G06T 2207/20081; G05B 2219/50391

(57) ABSTRACT

A detection unit of a control device detects a state of hardness of a target work surface from a captured image, which includes the target work surface, by using data acquired by machine-learning a relationship between the captured image and the state of hardness of the target work surface. The target work surface is a surface upon which the to-be-operated device applies force. A plurality of control modes are set, in accordance with differences in the state of hardness of the target work surface, as control modes for controlling the action of the to-be-operated device in response to a command output from the operation equipment. On the basis of the command and the state of hardness of the target work surface as detected by the detection unit, a selection unit selects a control mode to execute.

### TECHNICAL FIELD

The present invention relates to a technology for controlling an action of an operation target device in response to a command from operation equipment.

### BACKGROUND ART

In a remote controller that operates an operation target device, for example, a remote controller operation relevant to a command instructing a device action is determined in advance in such a way that a button A relates to the forward command for a device (moving body), a button C and the button A relates to a command for increasing a forward speed, and a button B relates to stop. In order for an operator to smoothly operate the operation target device with the remote controller, the operator necessarily memorizes the remote controller operation relevant to the command instructing the device to execute a desired action.

PTL 1 discloses a technology relating to movement control of a legged mobile robot that can move autonomously. In the technology disclosed in PTL 1, the state of a walking surface on which a biped walking robot walks is detected by using sensor values of various sensors mounted in the biped walking robot, and the walking action of the biped walking robot is controlled according to the detected state of a floor surface.

### CITATION LIST

### Patent Literature

[PTL 1] JP 2005-111654 A

### SUMMARY OF INVENTION

### Technical Problem

Some operation target devices to be operated by remote controllers can perform complicated movements. However, when the number of executable actions of operation target device increases, the remote controller operation becomes complicated, which may cause a problem that the operator cannot memorize the remote controller operation and cannot operate the operation target device as desired.

The present invention is devised in order to solve the above problem. That is, a main object of the present invention is to provide a technology capable of easily operating an operation target device with operation equipment such as a remote controller, even when the operation target device is capable of executing a complex action, while preventing complication of an operation of the operation equipment.

### Solution to Problem

In order to achieve the above object, a control device according to the present invention includes, as one form thereof:

a detection unit that detects a state of hardness of a target work surface from a captured image including the target work surface by using data obtained by machine-learning a relationship between the captured image in which the target work surface on which a force is applied by an operation target device is imaged and the state of hardness of the target work surface;

a selection unit that selects, as a control mode for controlling an action of the operation target device in response to a command output from operation equipment that operates the operation target device, a control mode to be executed from among a plurality of control modes set according to a difference in the state of hardness of the operation target device based on the command output from the operation equipment and the state of hardness of the target work surface detected by the detection unit; and

an execution unit that controls the action of the operation target device in the selected control mode.

A control system according to the present invention includes, as one form thereof:

operation equipment configured to operate an operation target device;

an imaging device configured to image a target work surface on which a force is applied by the operation target device; and

the control device of the present invention, the control device being configured to receive a captured image captured by the imaging device and including the target work surface and a command output from the operation equipment and control an action of the operation target device.

A control method according to the present invention includes, as one form thereof:

detecting a state of hardness of a target work surface from a captured image including the target work surface by using data obtained by machine-learning a relationship between the captured image in which the target work surface on which a force is applied by an operation target device is imaged and the state of hardness of the target work surface;

selecting, as a control mode for controlling an action of the operation target device in response to a command output from operation equipment that operates the operation target device, a control mode to be executed from among a plurality of control modes set according to a difference in the state of hardness of the operation target device based on the command output from the operation equipment and the detected state of hardness of the target work surface; and

controlling the action of the operation target device in the selected control mode.

A program storage medium according to the present invention, as one form thereof, stores a computer program for causing a computer to execute:

detecting a state of hardness of a target work surface from a captured image including the target work surface by using data obtained by machine-learning a relationship between the captured image in which the target work surface on which a force is applied by an operation target device is imaged and the state of hardness of the target work surface;

selecting, as a control mode for controlling an action of the operation target device in response to a command output from operation equipment that operates the operation target device, a control mode to be executed from among a plurality of control modes set according to a difference in the state of hardness of the operation target device based on the command output from the operation equipment and the detected state of hardness of the target work surface; and

controlling the action of the operation target device in the selected control mode.

### Advantageous Effects of Invention

According to the present invention, it is possible to easily operate the operation target device with the operation equipment, even when the operation target device is capable of executing a complex action, while preventing the complication of the operation of the operation equipment.

### [BRIEF DESCRIPTION OF DRAWINGS]

FIG. 1 is a block diagram illustrating a simplified functional configuration of a control device according to a first example embodiment of the present invention.

FIG. 2 is a block diagram illustrating a simplified configuration of a control system including the control device according to the first example embodiment.

FIG. 3 is a block diagram illustrating an example of a hardware configuration for achieving the control device of the first example embodiment.

FIG. 4 is a diagram for describing an example of mode selection data used to select a control mode for controlling an action of an operation target device in response to a command output from operation equipment.

FIG. 5 is a flowchart illustrating an example of a control operation of the control device of the first example embodiment.

FIG. 6 is a block diagram illustrating a configuration of a control device according to a second example embodiment of the present invention.

FIG. 7A is a diagram illustrating an example of a biped walking robot which is the operation target device.

FIG. 7B is a view illustrating a gripping action by a hand provided in the robot.

FIG. 7C is a view illustrating an action of bending an elbow of an arm provided in the robot.

FIG. 7D is a view illustrating an action of the robot standing on one leg.

FIG. 8 is a diagram for describing one of mode selection data in the second example embodiment.

FIG. 9 is a block diagram illustrating a configuration of a control device according to a third example embodiment of the present invention.

### EXAMPLE EMBODIMENT

Hereinafter, example embodiments according to the present invention will be described with reference to the drawings.

### First Example Embodiment

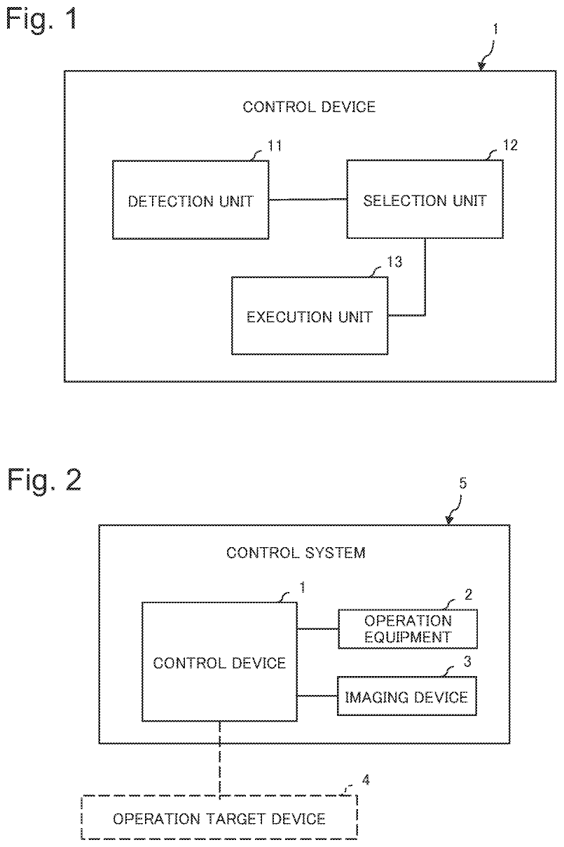

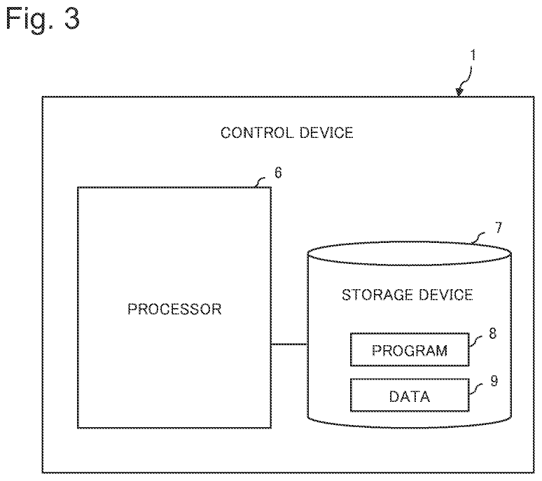

FIG. 1 is a block diagram illustrating a simplified functional configuration of a control device according to a first example embodiment of the present invention. FIG. 2 is a block diagram illustrating a simplified configuration of a control system including the control device according to the first example embodiment.

The control device 1 of the first example embodiment is connected to be communicable with operation equipment 2 and an imaging device 3 in a wireless or wired manner, thereby configuring a control system 5. The control system 5 is a system that operates an operation target device 4. Examples of the operation target device 4 include a humanoid robot, an automobile, a construction machine, a probe, and an industrial robot.

The operation equipment 2 is equipment used by an operator to operate the action of the operation target device 4, and includes an operation unit (not illustrated) such as an operation button, an operation lever, or a touch panel. A correspondence relationship between an operation pattern (for example, an operation pattern such as pressing the operation button or tilting the operation lever) in which the operator operates the operation equipment 2 and a command (signal) relevant to an action desired to be executed by the operation target device 4 is determined in advance. The operation equipment 2 is configured to output the command relevant to the operation pattern by the operator to the control device 1 in a case where the operator operates the operation unit.

The imaging device 3 is a device that images a target work surface on which the operation target device 4 applies a force, and, for example, is mounted on the operation target device 4 with an installation orientation and the like adjusted in such a way that the target work surface enters an imaging range. The imaging device 3 is configured to capture a moving image or a still image at every predetermined timing. The imaging device 3 may be installed on the operation target device 4 or the like in such a way that an imaging direction can be changed as necessary.

Here, as a specific example of the target work surface, the operation target device 4 is an automobile, and the target work surface relating to traveling of the automobile is a traveling surface on which a tire applies a force. The operation target device 4 is a humanoid robot, and the target work surface relating to walking of the humanoid robot is a walking surface on which a leg applies a force. The operation target device 4 is an arm-type robot which is one of industrial robots, and the target work surface relating to a gripping action of a gripping portion (hand) attached to the tip of the arm is a surface of an object gripped by the gripping portion. The operation target device 4 is a construction machine, and the target work surface relating to work of piling, hole digging, and grading on the ground by a work tool provided in the construction machine is the ground. The target work surface relating to work of drilling or spiral rotation by the construction machine or the probe which is the operation target device 4 is the surface of a drilling target member or a member to which a spiral is attached.

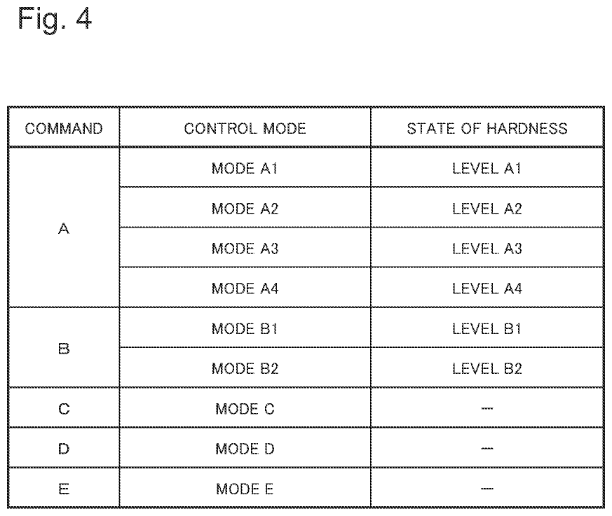

The control device 1 has a function of receiving a command output from the operation equipment 2 and controlling the action of the operation target device 4. FIG. 3 is a block diagram illustrating an example of a hardware configuration for achieving the control device 1. The control device 1 is a computer device, and includes a processor 6 such as a central processing unit (CPU) or a graphics processing unit (GPU), and a storage device 7.

The storage device 7 has a configuration for storing various computer programs (hereinafter, also referred to as a program) 8 and data 9. There are various types of storage devices, and any type of storage device may be adopted as the storage device 7, and the description of the configuration of the storage device is omitted. A plurality of types of storage devices may be mounted on the control device 1, and in this case, the plurality of types of storage devices are collectively described as the storage device 7, and the description of the configuration of the storage device 7 in this case is also omitted.

In the first example embodiment, hardness detection data and mode selection data are stored in the storage device 7 as the data 9.

The hardness detection data is data obtained by machine-learning a relationship between a captured image in which the target work surface is imaged and the state of hardness of the target work surface by using image data obtained by assigning information on the state of hardness of the target work surface to the captured image as teacher data. The hardness detection data is used when the state of hardness of the target work surface is detected, and is also referred to as a model, a dictionary, or the like.

The mode selection data is data representing a correspondence relationship between a command output from the operation equipment 2 and a control mode for controlling the action of the operation target device 4 in response to the command. In the first example embodiment, a plurality of control modes set according to a difference in the state of hardness of the target work surface are associated with the commands relevant to actions relating to the target work surface among the actions executed by the operation target device 4.

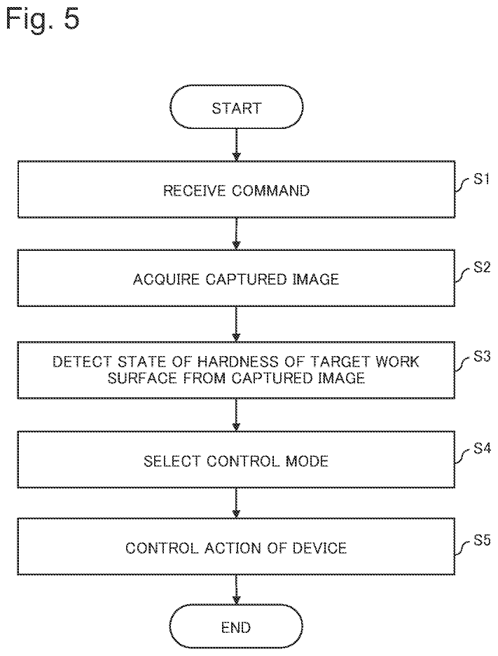

FIG. 4 is a diagram illustrating an example of the mode selection data. It is assumed that a command A illustrated in FIG. 4 is, for example, a command for causing the hand provided at the tip of the arm configuring the arm-type robot to grip an object. In a case where a metal object, a sponge, a rubber object, or the like is assumed as the object (gripping target object) to be gripped by the hand, the state of hardness of the target work surface (in other words, the object itself) of the gripping target object varies depending on the gripping target object. In this case, it is preferable to change a force for gripping the object, a way the fingers of the hand move, and the like according to the state of hardness of the object. For this reason, as the control mode of the gripping action by the hand, a plurality of different control modes are set according to the state of hardness of the gripping target object (target work surface). The mode selection data includes data in which information indicating a plurality of control modes relevant to the states of hardness of the gripping target object (target work surface) is associated with the command A.

That is, in this example, the target work surface relating to the command A is the surface of the gripping target object. In the example of FIG. 4, a range of hardness (softness (tenderness)) assumed as the state of hardness of the target work surface (the surface of the gripping target object) is divided into a plurality of (four) sections. For example, levels such as a level A1, a level A2, a level A3, and a level A4 are assigned to respective sections in order from a section on a soft (tender) side toward a section on a hard side. Control modes A1, A2, A3, and A4 are set to be relevant to the levels A1 to A4 of the states of hardness, respectively. The mode selection data includes data in which information indicating the control modes A1 to A4 is associated with the command A together with information indicating the state of hardness (levels A1 to A4).

Regarding a command B, a plurality of control modes B1 and B2 are set according to the state of hardness of the target work surface, the control modes being control modes for controlling the action of the operation target device in response to the command B. The mode selection data further includes data in which information indicating the control modes B1 and B2 is associated with the command B together with information indicating the state of hardness (levels B1 and B2).

On the other hand, it is assumed that a command C illustrated in FIG. 4 is, for example, a command to rotate the arm itself of the arm-type robot. In a case where the arm rotates, the presence of the target work surface on which the arm applies a force is not assumed, and only the control mode C is set as the control mode relevant to the command C. That is, the command C is a command of an action not relating to the target work surface, and data in which information indicating the control mode C is associated with the command C is included in the mode selection data.

Similarly to the command C, a command D and a command E are commands for instructing actions not relating to the target work surface, and control modes D and E are set to be relevant to the commands D and E, respectively. Data in which information indicating the control modes D and E is associated with the commands D and E is included in the mode selection data.

The storage device 7 further stores, as a program 8, a program for executing the above-described control mode for controlling the action of the operation target device 4. The storage device 7 stores, as the program 8, a program for causing the processor 6 to have the following functions.

That is, the processor 6 can have a function relevant to the program 8 by reading the program 8 stored in the storage device 7 and executing the program 8. In the first example embodiment, as functional units achieved by the processor 6, the control device 1 includes a detection unit 11, a selection unit 12, and an execution unit 13 as illustrated in FIG. 1.

The detection unit 11 has a function of detecting the state of hardness of the target work surface from the captured image including the target work surface by using a result acquired by machine-learning the relationship between the captured image, in which the target work surface on which the operation target device 4 applies a force is imaged, and the state of hardness of the target work surface. That is, the detection unit 11 acquires the captured image from the imaging device 3, and detects the state of hardness of the target work surface in the acquired captured image by using the hardness detection data stored in the storage device 7.

The selection unit 12 has a function of selecting a control mode to be executed from among a plurality of control modes set as the control mode for controlling the action of the operation target device 4 on the basis of the command output from the operation equipment 2.

That is, in the first example embodiment, as described above, the plurality of control modes are set as the control mode for controlling the action of the operation target device 4 on the basis of the command output from the operation equipment 2 which operates the operation target device 4. The storage device 7 stores the mode selection data as described above. In a case where the control device 1 receives the command output from operation equipment 2, the selection unit 12 selects (extracts) the control mode relevant to the command from the mode selection data. In a case where the information on the state of hardness of the target work surface is required when selecting the control mode, the selection unit 12 acquires the information on the state of hardness of the target work surface relating to the command from the operation equipment 2 from the detection unit 11. Then, the selection unit 12 uses the command and the information on the state of hardness of the target work surface to select the control mode to be executed from the mode selection data.

The execution unit 13 has a function of controlling the action of the operation target device 4 in the control mode selected by the selection unit 12. That is, the execution unit 13 controls the action of the operation target device 4 by executing the program 8 for executing the control mode selected by the selection unit 12.

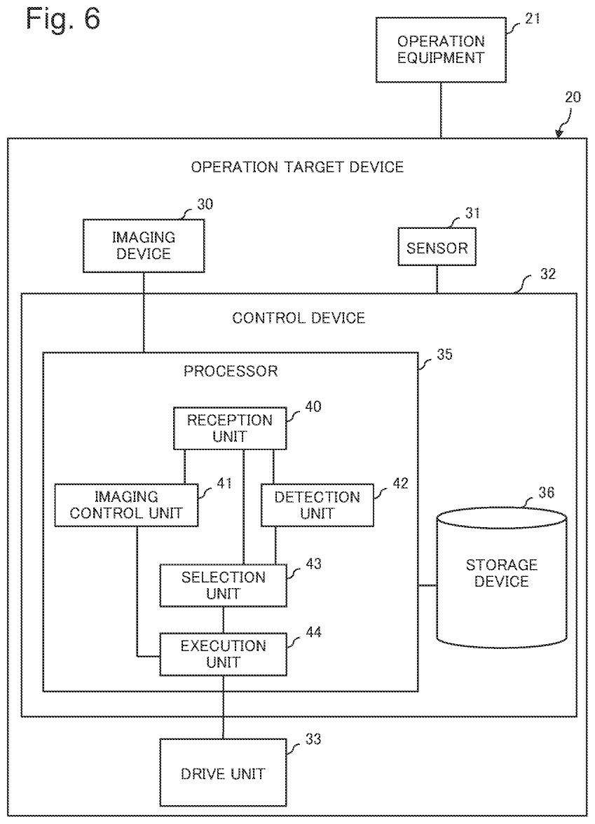

Hereinafter, an example of the action of the control device 1 which controls the action of the operation target device 4 will be described with reference to FIG. 5. FIG. 5 is a flowchart illustrating an example of a control procedure for controlling the action of the operation target device 4.

For example, in a case where the control device 1 receives a command output from the operation equipment 2 (step S1 in FIG. 5), and the command is a command instructing an action relating to the target work surface, the detection unit 11 acquires a captured image including the target work surface from the imaging device 3 (step S2). Then, from the acquired captured image, the detection unit 11 detects the state of hardness of the target work surface included in the captured image by using the hardness detection data of the storage device 7 (step S3).

Thereafter, the selection unit 12 selects a control mode to be executed from the mode selection data of the storage device 7 on the basis of the command received from the operation equipment 2 and the state of hardness of the target work surface detected by the detection unit 11 (step S4). Thereafter, the execution unit 13 controls the action of the operation target device 4 in the selected control mode (step S5).

In the control device 1 and the control system 5 of the first example embodiment, in a case where the command output from the operation equipment 2 is a command for instructing the action relating to the target work surface, even for the same command, the control device 1 and the control system 5 can cause the operation target device 4 to execute different actions according to the difference in the state of hardness of the target work surface. That is, the control device 1 and the control system 5 including the control device 1 can achieve an effect that even when the operation target device 4 is capable of executing a complex action, the operation target device 4 can be easily operated by the operation equipment 2 while preventing the complication of the operation of the operation equipment 2.

In the first example embodiment, in controlling the action relating to the target work surface in the operation target device 4, the plurality of control modes relevant to the states of hardness of the target work surface are set focusing on the difference in the state of hardness of the target work surface. Accordingly, only by receiving a simple command from the operation equipment 2, the control device 1 and the control system 5 can achieve the action relevant to the command in the action relating to the target work surface regardless of the difference in the state of hardness of the target work surface. That is, when the state of hardness of the target work surface is different, a difference occurs in the influence of the force of the reaction received by the operation target device 4 from the target work surface when a force is applied to the target work surface, the shape change of the target work surface, and the like on the operation target device 4. Therefore, in the action relating to the target work surface in the operation target device 4, when the same control is performed without considering the difference in the state of hardness of the target work surface, there is a possibility that the operation target device 4 fails in the action relevant to the command. On the other hand, when the plurality of different control modes are set according to the state of hardness of the target work surface, only by receiving a simple command from the operation equipment 2, the control device 1 and the control system 5 can achieve the action relevant to the command without being adversely affected by the difference in the state of hardness of the target work surface.

### Second Example Embodiment

Hereinafter, a second example embodiment according to the present invention will be described.

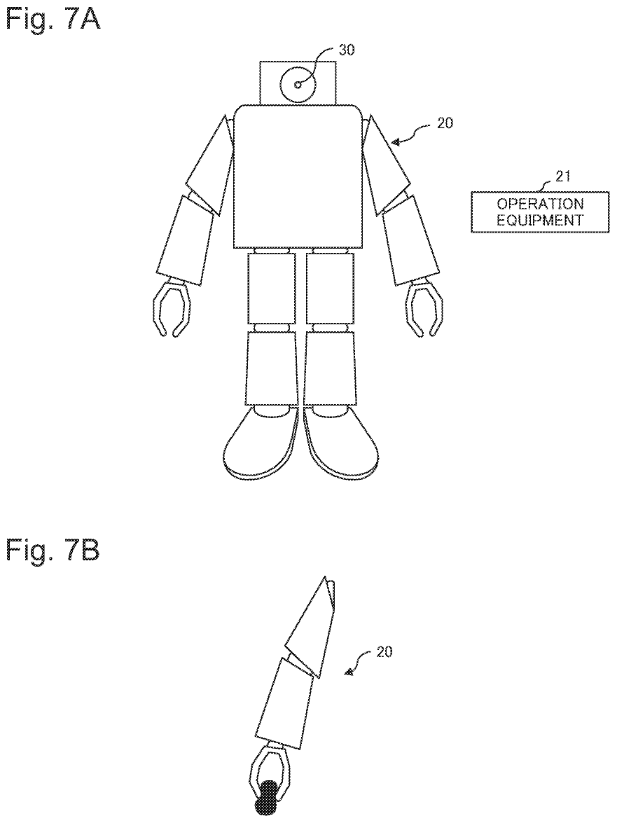

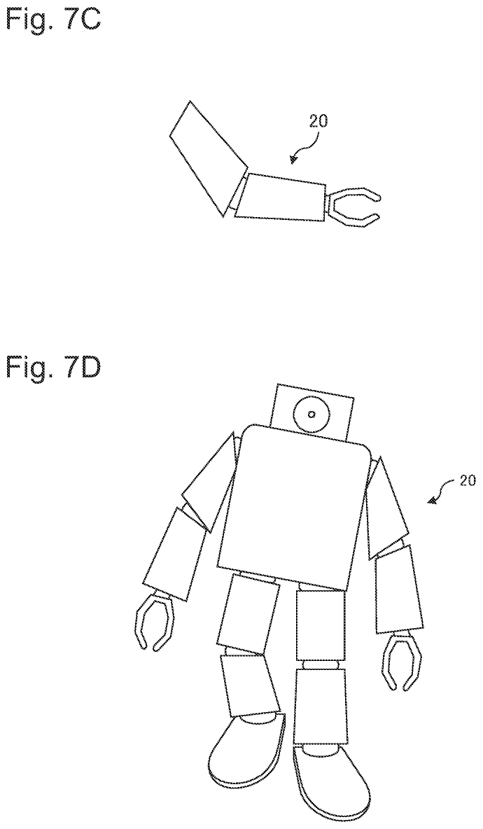

FIG. 6 is a block diagram illustrating a simplified configuration of an operation target device incorporating a control device according to a second example embodiment. In the second example embodiment, a control device 32 is built in an operation target device 20, and the operation target device 20 is a biped walking robot as illustrated in FIG. 7A. The operation target device 20 has a communication function of wirelessly communicating a signal with operation equipment 21. The operation equipment 21 is a so-called remote controller, and is equipment used by the operator to operate the action of the operation target device 20. Similarly to the operation equipment 2 described in the first example embodiment, the operation equipment 21 includes an operation unit such as an operation button, an operation lever, or a touch panel. Here, the aspect of the operation unit is not limited, and an appropriate aspect may be adopted, and the description of the operation unit is omitted.

A correspondence relationship between an operation pattern in which the operator operates the operation equipment 21 and a command (signal) relevant to an action desired to be executed by operation target device 20 is determined in advance. The operation equipment 21 is configured to output the command relevant to the operation pattern by the operator to operation target device 20 in the case of the operation by the operator.

The operation target device 20 is configured to act in response to the command (in other words, the operation pattern of the operation equipment 21 by the operator) received from operation equipment 21.

That is, in the second example embodiment, the operation target device 20 includes an imaging device 30, a sensor 31, a control device 32, and a drive unit 33.

The imaging device 30 is a device that images an information source in order to acquire information used when controlling the action of the operation target device 20. In the second example embodiment, the imaging device 30 images at least the target work surface on which the operation target device 20 applies a force. In the second example embodiment, the operation target device 20 is a biped walking robot. Actions according to the structure of the robot, such as a walking action, a bending action, a gripping action (see FIG. 7B), an elbow bending action (see FIG. 7C), an arm raising/lowering action, and a one-leg standing action (see FIG. 7D), are set as actions that can be executed by the device 20. Among the actions set in this manner, here, the walking action, the bending action, the one-leg standing action, and the gripping action are assumed as the actions relating to the target work surface. As the target work surface relating to the walking action, the bending action, and the one-leg standing action, a walking surface on which the leg of the robot applies a force is determined. As the target work surface relating to the gripping action, a surface of a target object to be gripped by the gripping portion provided at the tip of the arm of the robot is determined.

The imaging device 30 is mounted on, for example, the head of the operation target device 20 with an installation orientation and the like adjusted in such a way that the target work surface enters an imaging range. The imaging device 30 is configured to capture a moving image or a still image at every predetermined timing. If necessary, the imaging device 30 may be mounted on the operation target device 20 in a state where the imaging direction can be changed.

The sensor 31 has a configuration for detecting a physical quantity used for a control operation for controlling the action of the operation target device 20, and has a function for outputting sensor information indicating the detected physical quantity. Specific examples of the sensor 31 include a gyro that outputs information on an angular velocity, which is a physical quantity relating to the balance control and movement control of the body of the biped walking robot, an acceleration sensor that outputs information on an acceleration, which is a physical quantity, and a distance sensor that outputs information on a distance, which is a physical quantity. The type, number, and mounting location of the sensors 31 mounted on the operation target device 20 are appropriately determined on the basis of the action executed by the operation target device 20, and a detailed description of the sensor is omitted. In the second example embodiment, the imaging device 30 also functions as a type of the sensor 31.

The drive unit 33 includes a member to which power is supplied to move, and is controlled by the control device 32 to cause the operation target device (biped walking robot) 20 to achieve various actions. In the second example embodiment, a plurality of drive units are incorporated in the operation target device 20, but the drive units are collectively described as the drive unit 33. The type and number of members incorporated as the drive unit 33 in the operation target device 20 are not limited, and are appropriately set according to specifications and the like, but there are members corresponding to human joints as an example. With this member, the operation target device 20 can perform the walking action, the bending action, the gripping action, the one-leg standing action, the arm raising/lowering action, the elbow bending action, and the like as described above. In order to improve the efficiency of movement, wheels may be mounted on the side surfaces of the foot and the sole of the foot of the biped walking robot. Examples of the type of the wheel include an omni wheel (registered trademark) and a Mecanum wheel. A reaction wheel may be provided on, for example, the head of the biped walking robot to be used for posture control.

The control device 32 is a device that controls the action of the operation target device 20, and includes a processor 35 and a storage device 36.

The storage device 36 has a configuration for storing various computer programs (programs) and data. As described in the first example embodiment, there are various types of storage devices, and as in the first example embodiment, any type of storage device may be adopted as the storage device 36, and the detailed description of the storage device is omitted. A plurality of types of storage devices may be mounted on the control device 32, and in this case, the plurality of types of storage devices are collectively described as the storage device 36, and the detailed description of the storage device 36 in this case is also omitted.

In the second example embodiment, hardness detection data, shape detection data, imaging data, detection necessity determination data, and mode selection data are stored in the storage device 36.

The hardness detection data is data obtained by machine-learning a relationship between a captured image in which the target work surface is imaged and the state of hardness of the target work surface by using image data obtained by assigning information on the state of hardness of the target work surface to the captured image as teacher data. The hardness detection data is used when the state of hardness of the target work surface is detected, and is also referred to as a model, a dictionary, or the like.

The shape detection data is data obtained by machine-learning a relationship between the captured image in which the target work surface is imaged and the shape of the target work surface by using image data obtained by assigning information indicating the shape of the target work surface to the captured image as teacher data. The shape detection data is used when detecting the shape of the target work surface, and is also referred to as a model, a dictionary, or the like.

State detection data may be used for the target work surface of which the state of hardness and the shape are to be detected. The state detection data is data obtained by machine-learning a relationship between the captured image in which the target work surface is imaged and the state of hardness and shape of the target work surface by using image data obtained by assigning information on the state of hardness and shape of the target work surface to the captured image as teacher data. This state detection data is also stored in the storage device 36.

The imaging data is used when it is determined whether imaging by the imaging device 30 in response to the command output from the operation equipment 21 is necessary. The imaging data is data in which the command output from the operation equipment 21, information indicating the necessity of the imaging by the imaging device 30 according to the command, and information indicating an imaging target in a case where the imaging is necessary are associated.

The detection necessity determination data is data used when it is determined whether the operation of the detection unit 42 in response to the command output from the operation equipment 21 is necessary. The detection necessity determination data is data in which the command output from the operation equipment 21 is associated with information indicating the necessity of the operation of the detection unit 42 according to the command and is further associated also with information indicating the type of the detection operation.

Similar to the mode selection data described in the first example embodiment, the mode selection data is data representing a correspondence relationship between the command output from the operation equipment 21 and a control mode for controlling the action of the operation target device 20 in response to the command. That is, the mode selection data includes data in which the command output from operation equipment 21 is associated with only one piece of information indicating the control mode for controlling the action in response to the command. The mode selection data also includes data in which the command relevant to the action relating to the target work surface is associated with information indicating a plurality of control modes which are control modes for controlling the action in response to the command and set according to the difference in the state of hardness of the target work surface. In the second example embodiment, regarding the command in a case where a plurality of types of target work surfaces having different shapes are assumed among the commands relevant to the actions relating to the target work surface, a plurality of control modes are set in consideration of not only the state of hardness of the target work surface but also the difference in shape. The mode selection data also includes data in which such a command is associated with information indicating the plurality of control modes which are control modes for controlling the action in response to the command and set in consideration of not only the state of hardness of the target work surface but also the difference in shape.

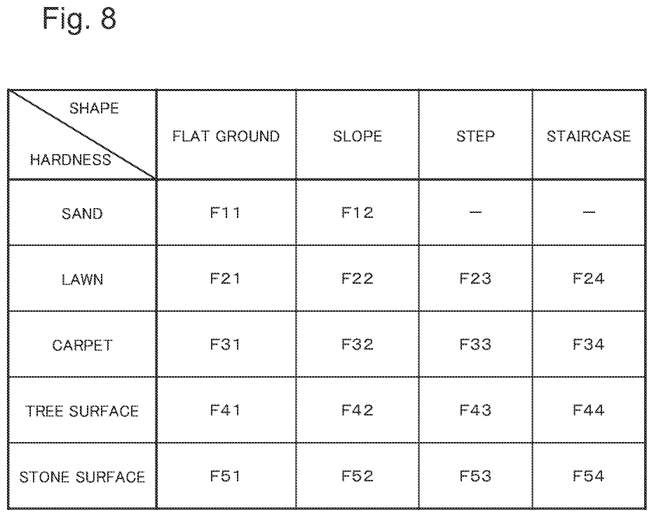

In the action of the operation target device 20, the walking action is exemplified as a specific example of the action in which a plurality of control modes are set in consideration of not only the state of hardness of the target work surface but also the difference in shape. FIG. 8 is a diagram illustrating an example of data relating to a walking command (walking action) included in the mode selection data. That is, the data illustrated in FIG. 8 is data which, in a case where a command instructing the biped walking robot which is the operation target device 20 to walk is output from the operation equipment 21, is used to select a control mode for controlling the action in response to the command.

In the example of FIG. 8, sand, lawn, a carpet, a tree surface, and a stone surface are assumed as the state of hardness of the walking surface which is the target work surface. As the shape of the walking surface, a flat ground, a slope, a step, and a staircase are assumed. In consideration of such a state of hardness and the shape of the walking surface, a plurality of control modes for controlling the walking action of the biped walking robot are set. For example, in a case where the state of hardness of the walking surface is a carpet, and the shape of the walking surface is a flat ground, a control mode F31 is set in the mode selection data illustrated in FIG. 8 as the control mode for controlling the walking action of the biped walking robot. In a case where the state of hardness of the walking surface is a tree surface, and the shape of the walking surface is a flat ground, a control mode F41 is set in the mode selection data illustrated in FIG. 8 as the control mode for controlling the walking action of the biped walking robot. Here, it is assumed that a Mecanum wheel is provided on the sole of the foot of the biped walking robot which is the operation target device 20. For example, in the control mode F31 (a control mode relevant to a carpet and a flat ground) and the control mode F41 (a control mode relevant to a tree surface and a flat ground), the Mecanum wheel is controlled in such a way that a propulsion force is the same, but the movement of the leg is controlled in such a way that a walking pitch is higher in the control mode F41 than in the control mode F31. In other words, the movement of the legs is controlled in such a way that the walking pitch (that is, the number of steps per unit time) in the control mode F31 is higher than the walking pitch in the control mode F41. In the control mode F31 and the control mode F41, the movement of the leg is controlled in such a way that a walking speed increases in response to a speed-increase command from the operation equipment 21, and the movement of the arm is controlled in such a way that the bending angle of an elbow becomes acute when the walking speed increases. As described above, with respect to the same command, a plurality of different control modes are set according to the state of hardness and the shape of the walking surface. Therefore, even when the same walking command is output from the operation equipment 21 toward the operation target device 20 by the operation of the operator, when the state of hardness and the shape of the walking surface on which the operation target device 20 walks are different, there is a difference in the walking action of the operation target device 20.

In the example of FIG. 8, a flat ground, a slope, a step, and a staircase are set as the shape of the walking surface. Alternatively, the shape of the walking surface may be set more in detail, for example, to a flat ground with unevenness such as a gravel road or a flat land without unevenness such as a pavement road. Similarly, the state of hardness may be set more in detail.

In the second example embodiment, as described above, the bending action, the one-leg standing action, and the gripping action other than the walking action are set as the actions relating to the target work surface. Regarding the commands relevant to the bending action, the one-leg standing action, and the gripping action, for example, a plurality of control modes are set in consideration of a difference in only the state of hardness among the state of hardness and the shape. In this case, the mode selection data relating to the command relevant to each of the bending action, the one-leg standing action, and the gripping action is data in which the command is associated with information indicating the plurality of control modes set according to the difference in the state of hardness of the target work surface.

In the second example embodiment, the biped walking robot can also perform an action (for example, an action of simply bending the elbow, an action of raising and lowering the arm, or an action of turning the upper body) other than the action relating to the target work surface. In the command for instructing such an action, one control mode for controlling the action is set.

The control operation in the control mode set as described above includes an operation relevant to the command, such as designating the bending angle of the elbow, output from the operation equipment 21 or an operation using the sensor information of the sensor 31.

Various kinds of data as described above are stored in the storage device 36. The storage device 36 stores a program for executing the control mode and a program for causing the processor 35 to have the following functions.

The processor 35 includes a CPU and a GPU. The processor 35 can have a function relevant to the program by reading the program stored in the storage device 36 and executing the program. That is, in the second example embodiment, as functional units achieved by the processor 35, a reception unit 40, an imaging control unit 41, a detection unit 42, a selection unit 43, and an execution unit 44 are provided as illustrated in FIG. 6.

The reception unit 40 has a function of receiving the command output from operation equipment 21 via a communication circuit (not illustrated) included in the control device 32. The reception unit 40 has a function of collating the received command with the imaging data stored in the storage device 36 and detecting whether the imaging by the imaging device 30 according to the command is necessary from the imaging necessity information of the imaging data. The reception unit 40 has a function of, in a case where it is detected that the imaging by the imaging device 30 is necessary, extracting information on the imaging target according to the received command from the imaging data, associating the extracted information on the imaging target with the command, and further outputting the information to the imaging control unit 41 together with an imaging request. The reception unit 40 has a function of collating the received command with the detection necessity determination data stored in the storage device 36 and detecting information on whether the operation of the detection unit 42 is necessary in relation to the received command from the detection necessity determination data. The reception unit 40 has a function of, in a case where it is detected that the operation of the detection unit 42 is necessary, outputting information indicating the type of the detection operation to the detection unit 42 together with an operation start command. The reception unit 40 has a function of outputting the received command to the selection unit 43.

The imaging control unit 41 has a function of controlling the operation of the imaging device 30. For example, the imaging control unit 41 controls start and stop of the imaging by the imaging device 30 according to a predetermined rule. As a specific example of the rule, when the imaging request is received from the reception unit 40 or the execution unit 44, the imaging control unit 41 controls the imaging device 30 to start imaging. When an elapsed time from the reception of the imaging request from the reception unit 40 reaches a threshold value or when the control operation by the execution unit 44 is ended, the imaging control unit 41 controls the imaging device 30 to stop the imaging.

In a case where the imaging control unit 41 receives the information on the imaging target together with the imaging request from the reception unit 40, the imaging direction of the imaging device 30 is adjusted in such a way that the imaging target can be imaged. The imaging target is, for example, a target work surface according to a command, a robot component such as a hand for acquiring information used for the action control of the biped walking robot, or a peripheral region of the robot.

In the case of receiving the operation start command from the reception unit 40, the detection unit 42 has a function of executing the detection operation according to the information received together with the operation start command and indicating the type of the detection operation. In the second example embodiment, as the detection operation by the detection unit 42, an operation of detecting the state of hardness of the target work surface in the captured image captured by the imaging device 30 and an operation of detecting the state of hardness and the shape of the target work surface in the captured image are set.

That is, in the second example embodiment, the detection unit 42 acquires the image captured by the imaging device 30 and including the target work surface on the basis of the operation start command from the reception unit 40 and the information indicating the detection operation, and detects the state of hardness of the target work surface from the captured image by using the hardness detection data of the storage device 36. Alternatively, the detection unit 42 uses the hardness detection data and the shape detection data of the storage device 36 or the state detection data instead of the hardness detection data and the shape detection data to detect the state of hardness and the shape of the target work surface from the captured image by the imaging device 30. In other words, the detection unit 42 detects at least the state of hardness among the state of hardness and the shape of the target work surface from the captured image by a so-called artificial intelligence (AI) technology.

When receiving the command output from the operation equipment 21 via the reception unit 40, the selection unit 43 has a function of collating the received command with the mode selection data in storage device 36 and selecting the control mode relevant to the command. That is, in a case where the mode selection data has one piece of information indicating the control mode associated with the received command, the selection unit 43 selects (extracts) the information on the control mode from the mode selection data on the basis of the received command. In a case where the mode selection data has a plurality of pieces of information indicating the control mode associated with the received command due to the difference in the state of hardness of the target work surface, the selection unit 43 acquires the information on the state of hardness of the target work surface detected from the captured image by the detection unit 42. The selection unit 43 uses the acquired information on the state of hardness of the target work surface and the received command to select the information on the control mode from the mode selection data. In a case where the mode selection data has a plurality of pieces of information indicating the control mode associated with the received command due to the difference in the state of hardness and the shape of the target work surface, the selection unit 43 acquires the information on the state of hardness and the shape of the target work surface detected from the captured image by the detection unit 42. The selection unit 43 uses the acquired information on the state of hardness and the shape of the target work surface and the received command to select the information on the control mode from the mode selection data.

The selection unit 43 outputs the information indicating the control mode selected as described above to the execution unit 44.

The execution unit 44 has a function of reading a program for executing the selected control mode from the storage device 36 and executing the program in order to control the action of the operation target device 20 in the control mode selected by the selection unit 43. The execution unit 44 may output an imaging request and information on the imaging target to the imaging control unit 41 according to the program.

In the second example embodiment, the control device 32, the imaging device 30, the sensor 31, and the operation equipment 21 as described above configure a control system that controls the action of the operation target device 20.

The control device 32 of the second example embodiment and the control system including the control device can obtain the same effects as those of the first example embodiment. That is, even for the same command output from the operation equipment 21, the control device 32 of the second example embodiment and the control system including the control device can execute different operations according to the state of hardness of the target work surface on which the operation target device 20 applies a force or according to the state of hardness and the shape. Accordingly, the control device 32 according to the second example embodiment and the control system including the control device can achieve an effect that even when the operation target device 20 is capable of executing a complex action, the operation target device 20 can be easily operated by the operation equipment 21 while preventing the complication of the operation of the operation equipment 21.

Since the control device 32 according to the second example embodiment and the control system including the control device have a configuration for detecting the state of hardness and the shape of the target work surface from the captured image, it is not necessary to provide a sensor for detecting the state of hardness of the target work surface.

### Third Example Embodiment

Hereinafter, a third example embodiment according to the present invention will be described. In the description of the third example embodiment, the same reference numerals are given to the parts having the same names as those of the components configuring the control device and the control system in the second example embodiment, and redundant description of the common parts is omitted.

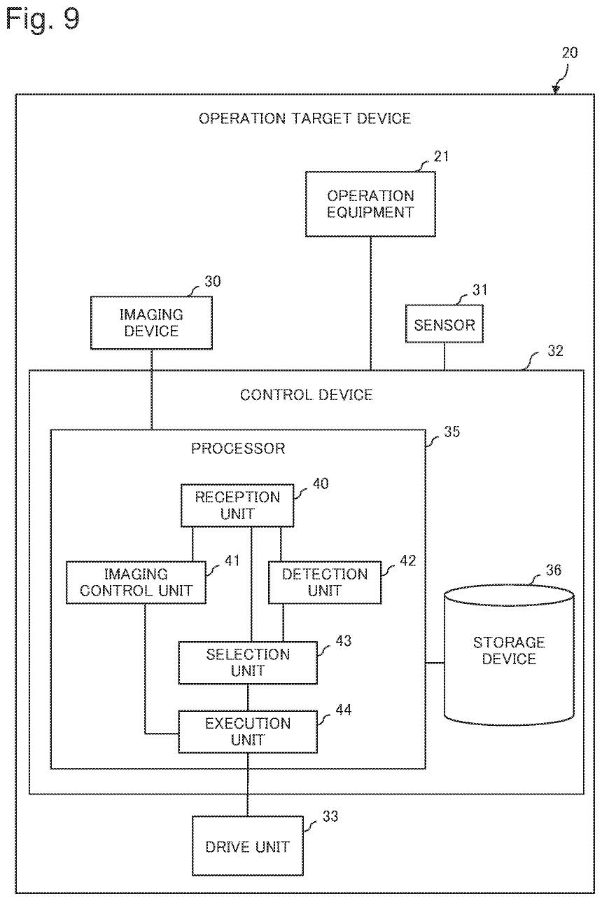

In the third example embodiment, the operation target device 20 is an automobile. As illustrated in FIG. 9, the operation target device 20 is mounted with the operation equipment 21 and a seat (not illustrated) on which the operator who operates the operation equipment 21 is positioned. The operation equipment 21 includes, for example, a steering wheel, a lever, and a pedal. The imaging device 30 is a device that images at least the front of the automobile. The drive unit 33 includes at least members relating to traveling of the automobile such as a member for adjusting power for rotating tires and a member for changing the traveling direction of the automobile, and is controlled by the control device 32 to achieve various actions of the automobile.

There are a wide variety of actions that can be executed by the automobile which is the operation target device 20, and the third example embodiment is characterized by a method of controlling an action relating to traveling among the actions. The target work surface on which a force is applied by the action relating to the traveling of the operation target device 20 is a traveling surface on which a force is applied by the tires, and it is assumed that the traveling surface has a plurality of states of hardness and shapes. For example, as the state of hardness of the traveling surface, sand, lawn, soil surface, asphalt pavement surface (soft), asphalt pavement surface (hard), and the like are assumed. As the shape of the traveling surface, a flat ground, an upward slope, a downward slope, a gravel road, an unpaved mountain road, and the like are assumed.

As the action relating to traveling, there are forward movement and acceleration according to the operation of an accelerator pedal as the operation equipment 21, deceleration and stop according to the operation of a brake pedal as the operation equipment 21, and a change of the traveling direction according to the operation of a steering wheel as the operation equipment 21. As the action relating to traveling, there is also an action of changing the traveling direction to either forward or backward by operating a shift lever as the operation equipment 21.

In the third example embodiment, a plurality of control modes different according to the state of hardness of the traveling surface are set to be relevant to the command from the operation equipment 21 instructing such an action relating to traveling. In the action relating to traveling in the automobile, various different actions are assumed according to the state of hardness of the traveling surface, and various control modes for controlling such various actions are also conceivable. Here, it is assumed that an appropriate control mode in consideration of the functions and the like mounted on the automobile is selected and adopted as a control mode for controlling the action relating to traveling according to the state of hardness of the traveling surface, and the description thereof is omitted. The control mode relevant to the command to move the automobile forward by the operation of the operation equipment 21 may include, for example, an automatic driving mode in which a white line representing a lane is detected from the captured image including the traveling surface by the imaging device 30, and the traveling direction of the automobile is controlled by using the white line.

The storage device 36 according to the third example embodiment stores data and programs relating to the action control of the automobile which is the operation target device instead of the data and programs 32 relating to the action control of the biped walking robot which is the operation target device in the second example embodiment.

The reception unit 40, the imaging control unit 41, the detection unit 42, the selection unit 43, and the execution unit 44, which are the functional units included in the control device 32 in the third example embodiment, are similar to those in the second example embodiment except that data and programs to be used are different depending on the difference of the operation target device. Here, the description of these functional units is omitted.

Also in the third example embodiment, the same effects as those of the first and second example embodiments can be obtained. In the third example embodiment, an example in which the operation target device 20 is an automobile is described. Alternatively, the third example embodiment can also be applied to construction machine as the operation target device 20. In the case of the construction machine, the surface of a work target on which the construction machine performs work is assumed as the target work surface, and a plurality of control modes different according to the state of hardness of the surface of the work target or according to the state of hardness and the shape are set as control modes for controlling the work action of such a construction machine.

### Other Example Embodiments

The present invention is not limited to the first to third example embodiments, and various example embodiments can be adopted. For example, in the second example embodiment, the detection unit 42, the selection unit 43, and the execution unit 44, which are the functional units of the control device, are provided in the operation target device 20. Alternatively, for example, it is assumed that restrictions on the size and weight of the operation equipment 21 are loosened in such a way that a slightly large control device 32 capable of performing processing using the AI technology can be mounted on the operation equipment 21. In such a case, the detection unit 42 and the selection unit 43 may be included in the control device provided in the operation equipment 21, and the execution unit 44 may be included in the control device 32 in the operation target device 20. A control device (server) separate from the operation equipment 21 and the operation target device 20 may be provided, the detection unit 42 and the selection unit 43 may be provided in the control device, and the execution unit 44 may be provided in the control device 32 in the operation target device 20. As described above, the detection unit 42, the selection unit 43, and the execution unit 44 may be appropriately distributed and arranged.

The commands output from the operation equipment 2 and 21 in the first to third example embodiments are not limited to the commands that instruct respective actions executed by the operation target devices 4 and 20. For example, the command may be a start command of a continuous action that causes the humanoid robot to sequentially execute a series of a plurality of actions such as moving forward→stopping before a small stone ahead→bending to pick up the small stone→gripping the small stone→raising the body→returning.

In the second and third example embodiments, the control device 32 may be also provided to have a function of estimating the height of the step in the traveling direction of the operation target device 20 from the captured image by using, for example, the AI technology and a function of estimating the roughness of the road surface.

The present invention has been described above using the above-described example embodiments as examples. However, the present invention is not limited to the above-described example embodiments. That is, the present invention can apply various aspects that can be understood by those skilled in the art within the scope of the present invention.

This application is based upon and claims the benefit of priority from Japanese patent application No. 2019-201100, filed on Nov. 6, 2019, the disclosure of which is incorporated herein in its entirety by reference.

### REFERENCE SIGNS LIST

1, 32 control device
2, 21 operation equipment
3, 30 imaging device
5 control system
11, 42 detection unit
12, 43 selection unit
13, 44 execution unit
31 sensor

What is claimed is:

1. A control device comprising:
at least one processor configured to:
detect a state of hardness of a target work surface from a captured image including the target work surface by using data obtained by machine-learning, the target work surface being a surface on which a force is applied by an operation target device, the data being obtained by machine-learning a relationship between the captured image in and the state of hardness of the target work surface;
select, as a control mode for controlling an action of the operation target device in response to a command output from operation equipment that operates the operation target device, a control mode to be executed from among a plurality of control modes set according to a difference in the state of hardness of the operation target device based on the command output from the operation equipment and the detected state of hardness of the target work surface; and
control the action of the operation target device in the selected control mode.

2. The control device according to claim 1, wherein
the at least one processor further detects a shape of the target work surface from the captured image by using data obtained by machine-learning a relationship between the captured image in which the target work surface is imaged and the shape of the target work surface, and
the at least one processor selects the control mode to be executed from a plurality of control modes set according to a difference in the state of hardness and the shape of the target work surface based on the command output from the operation equipment and the detected state of hardness and the detected shape of the target work surface.

3. The control device according to claim 1, wherein
the at least one processor controls the action of the operation target device in the selected control mode by using at least one of sensor information acquired from a sensor that detects a physical quantity used for an action control of the operation target device or information acquired from the captured image.

4. The control device according to claim 1, wherein
a plurality of types of commands output from the operation equipment include a command for instructing start of a series of a plurality of actions to be executed sequentially by the operation target device.

5. (canceled)

6. A control method comprising:
by a computer,
detecting a state of hardness of a target work surface from a captured image including the target work surface by using data obtained by machine-learning, the target work surface being a surface on which a force is applied by an operation target device, the data being obtained by machine-learning a relationship between the captured image and the state of hardness of the target work surface;
selecting, as a control mode for controlling an action of the operation target device in response to a command output from operation equipment that operates the operation target device, a control mode to be executed from among a plurality of control modes set according to a difference in the state of hardness of the operation target device based on the command output from the operation equipment and the detected state of hardness of the target work surface; and
controlling the action of the operation target device in the selected control mode.

7. A non-transitory program storage medium storing a computer program for causing a computer to execute:
detecting a state of hardness of a target work surface from a captured image including the target work surface by using data obtained by machine-learning, the target work surface being a surface on which a force is applied by an operation target device, the data being obtained by machine-learning a relationship between the captured image and the state of hardness of the target work surface;
selecting, as a control mode for controlling an action of the operation target device based on a command output from operation equipment that operates the operation target device, a control mode to be executed from among a plurality of control modes set according to a difference in the state of hardness of the operation target device based on the command output from the operation equipment and the detected state of hardness of the target work surface; and
controlling the action of the operation target device in the selected control mode.
